(19) United States
(12) Patent Application Publication
(10) Pub. No.: US 2009/0164831 A1
(43) Pub. Date: Jun. 25, 2009

(54) Controlled Default OTP Settings for ASICs

(76) Inventors: Hemanth K. Birru, Pennsburg, PA (US); Clinton H. Holder, JR., Lehigh, PA (US); Kang W. Lee, Allentown, PA (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/959,719

(22) Filed: Dec. 19, 2007

(51) Int. Cl. G06F 1/08

(52) U.S. Cl. 713/601

(57) ABSTRACT

An OTP and Reset Assert Counter and a method for protecting one-time programmable memory settings during read-out from an OTP memory block. The OTP memory block is set at ground and in a reset mode with a clock driven External Reset (RSTB) signal set at ground true active. A Delay Counter is programmed with a time delay to correspond with the time that is inherently needed by the OTP Memory block to complete a read-out process that begins with the External Reset (RSTB) signal being set to HIGH; and an input Clock signal is delayed by the Delay Counter for a duration of the time delay that begins with the External Reset (RSTB) signal being set to HIGH.

### FIELD OF THE INVENTION

This invention relates to protection of settings that have been programmed into an integrated circuit device, and more specifically, to protection of one-time programmable default settings of OTP memories of ASICs.

### BACKGROUND

U.S. Pat. No. 7,165,137 refers to a system for booting a microprocessor controlled system wherein a basic interface between the processor and peripheral devices is copied from an application and file storage device into random access memory without usage of the microprocessor or need for a non-volatile code storage device.

According to U.S. Pat. No. 5,454,114 a microcontroller is selectively reset to prevent it from executing programs and instructions for purposes of generating control signals, and is maintained in the reset condition despite initiation of a removal from the reset condition, until the power supplied by the power supply is in a predetermined range and the clock frequency supplied by the clock is stable.

### SUMMARY OF THE INVENTION

The invention relates to control of OTP default settings, including OTP security protection measures that have been programmed into an OTP Memory block of an ASIC semiconductor chip. The invention provides a time delay, according to which a Chip Logic Block and its internal ASIC or microprocessor, or both, whichever are present, are delayed ftom going to inactive reset, until the OTP Memory and chip at inactive reset are configured to their fully operational modes.

### BRIEF DESCRIPTION OF THE DRAWINGS

FIG. 1 is a diagrammatic view of an ASIC chip.

FIG. 2 is a diagrammatic view of an OTP and Reset Assert Counter of the ASIC chip disclosed by FIG. 1.

FIG. 3 is a waveform diagram indicating signal time delays according to the invention.

### DETAILED DESCRIPTION

An External Reset device is used to read one-time programmable (OTP) memories with OTP bit (byte) contents in the form of fixed default settings of parameters to control the operation of the OTP memories, such as, electronic serial numbers (ESN), feature controls and preset adjustable constants for complex algorithms. Additional default settings programmed into the OTP memories include security protection measures, such as, write and erase protection and unauthorized access protection. After removal of the External Reset device, the OTP Memory is available for power-up to an operational mode.

Further, after power-up is internally applied to an OTP Memory, the controller of the OTP Memory actively interfaces with a system microprocessor that takes control of system operation. The processor speed can re-boot and take control of system operation faster than the time it takes for the OTP Memory to read out its OTP contents, which includes one-time programmed default settings and programmed security protection measures. Consequently, an interval of time occurs during which the processor can operate the system using incorrectly read default settings, and can subvert the security protection measures. The OTP memory is vulnerable to external control signals that could override the intended purpose of one or more OTP bits. For example, the purpose of an OTP bit that modifies a boot memory map such that an external memory blocked from use can be subverted by external control signals. Thus, protection is desired for protecting the OTP contents until read-out of the OTP contents is completed.

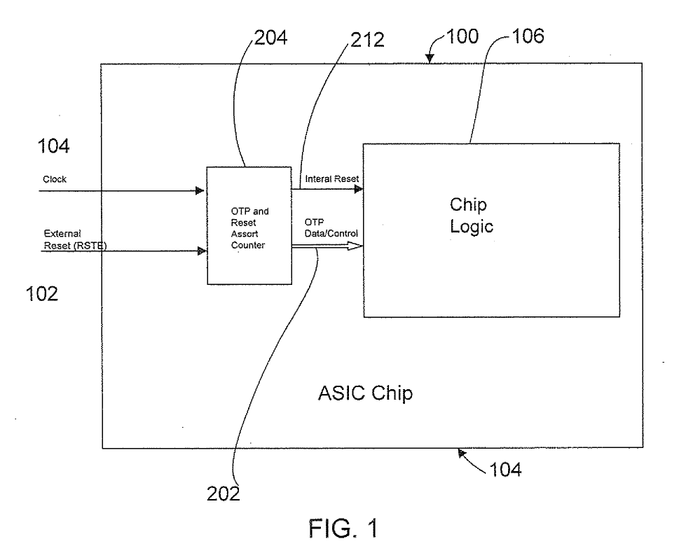

FIG. 1 discloses a diagrammatic architecture of a semiconductor, ASIC chip 100. The ASIC chip 100 includes a device that receives input signals from external sources, not shown. The input signals include, a clock driven, input External Reset (RSTB) signal 102 and an input clock signal 104. In the detailed description herein, a referral to each “signal” shall refer to an electronic form of the signal, and shall refer to a physical electrical conductor path conveying the signal in a direction, as depicted by a corresponding arrow in the drawing figures.

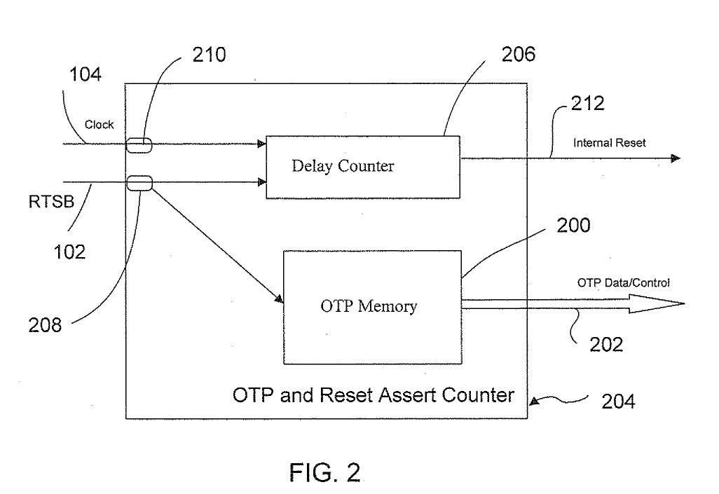

The ASIC chip 100 has a Chip Logic block 106, FIG. 1, in which reside the ASIC internal processor and logic circuits that control and perform the ASIC functions and operations of the ASIC chip. Further, the ASIC chip 100 has a one-time programmable (OTP) Memory block 200, FIG. 2, that has been programmed with one-time memory settings, including other memory contents, that read-out as an output over internal OTP Data/Controls signals 202 to the Chip Logic block 106. The OTP Memory block 200 is further programmed with security protection settings, in memory, which provide write and erase protection and which protect against an attempt to gain unauthorized access to the OTP Memory block settings and the Chip Logic block 106. Upon completed read-out of the memory settings, the OTP Memory block 200 is rendered fully configured. The OTP Data/Controls signals 202 further include both OTP data signals and OTP control signals that fully configure the Chip Logic block 106 for performance of the functions and operations of the ASIC chip 100. Upon completed read-out of the memory settings, the Chip Logic block 106 is rendered fully configured.

Before the OTP Memory block 200 is fully operational, the memory settings can be read-out completely over the internal OTP Data/Controls signals 202, especially during clock driven reset of the ASIC chip 100. Thus, once set, all such memory settings can be protected during the time it takes for the OTP Memory block 200 to complete its read out of such memory settings. An embodiment of the invention provides such protection without a need to invoke or rely upon the power-up reset and re-boot procedures internal to a system microprocessor. According to an embodiment of the invention, the memory settings are protected by a diode-free, OTP and Reset Assert Counter 204. The OTP and Reset Assert Counter 204, being diode-free, reduces the overall cost of construction, speeds up the switching times compared to that of diodes, and reduces power consumption that would be consumed by diodes.

Typically, the ASIC chip 100 is an external device that is part of an electronic system, not shown, under the control of a system microprocessor having an operational speed that attains full power-up and begins executing system commands before the slower speed, OTP Memory block 200 has completed its read-out of the OTP Memory settings. A partially completed read-out of the memory settings is likely to result. Thereby, the read-out memory settings of the OTP Memory block 200 are vulnerable to being incorrect, since they have not fully completed their read-out cycle, and the security protection measures in memory are vulnerable to being rendered ineffective as security protection, since they have not fully completed their read-out cycle. Moreover, the system microprocessor would begin executing error-prone commands which have relied on incorrectly read-out memory settings of the OTP Memory block 200.

FIG. 2 discloses the OTP and Reset Assert Counter 204 in further detail as an integrated semiconductor device that is further integrated with the ASIC chip 100. The OTP Memory block 200 is combined with a Delay Counter 206 and integrated in the semiconductor architecture of the OTP and Reset Assert Counter 204 semiconductor device, and each is supplied with the External Reset (RSTB) signal 102. The External Reset (RSTB) signal 102 is supplied to one of the semiconductor device inputs 208 in the form of pins or terminals that plug in, or pads that surface mount, the ASIC chip 100 to a circuit board or card, not shown. The External Reset RSTB signal 102 divides internally of the ASIC chip 100 to input the OTP Memory block 200 and the Delay Counter 206.

FIG. 2 discloses that the clock signal 104 is supplied over another chip input 210 in the form of a pin, pad or terminal of the OTP and Reset Assert Counter 204 to the Delay Counter 206. The Delay Counter 206 has, for example, a multiplex-programmable internal time delay that is programmed by an external multiplexer, not shown, to delay the Clock signal 104 for a duration that is programmed to correspond with the time that is inherently needed by the architecture and construction of the OTP Memory block 200 to complete the read-out process.

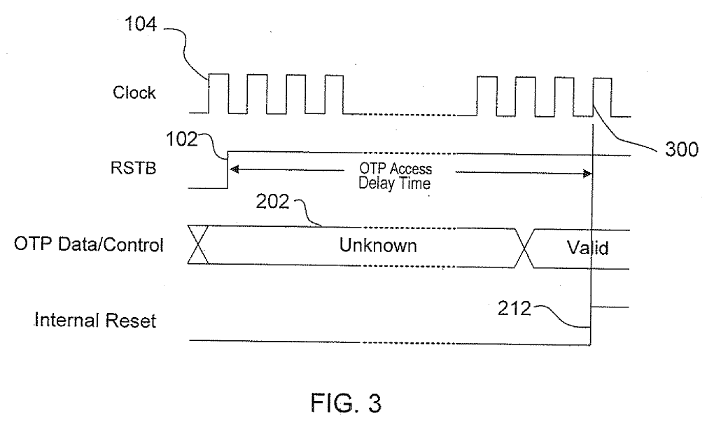

Moreover, as disclosed by FIG. 3, the Delay counter 206 uses the Clock signal 104 to count the time delay 300; and for determining its duration upon attaining a programmed setting of numbered counts. During the time delay 300 the OTP Memory block 200 completes the read-out cycle required for complete read-out of the memory settings, including other memory contents thereof. At the end of the programmed delay, the Delay Counter 206 releases the Clock signal 104 to begin a delayed Internal Reset signal 212. The beginning of the Internal Reset signal 212 asserts the end of the time delay 300, asserts that read-out is completed and asserts that the OTP Memory block 200 and the Chip Logic block 106 are fully configured.

In the OTP and Reset Assert Counter 204 the RSTB signal 102 is at ground (LOW state) true active, such that, the RSTB signal 102 at ground true active sets all of the internal circuits in the Delay Counter 206, the OTP Memory block 200 and the Chip Logic block 106, respectively, in an Active Reset mode at LOW. While in the Active Reset mode, the OTP Memory block 200 is in standby mode, and is not reading out the memory settings, including other memory contents thereof. Further, while in Active Reset mode the Delay Counter 206 and the Chip Logic block 106 are in standby mode and are not operational.

During an Active Reset mode, the OTP Memory block 200 is programmed with the memory settings and other memory contents by an external programming apparatus, not shown. At completion of the Active Reset mode the external programming apparatus is removed and the Active Reset mode is terminated.

The External Reset RSTB signal 102 goes HIGH, relative to ground, when the Active Reset mode is terminated, or for example, when set to HIGH under the control of a systems microprocessor of an electronic system of which the ASIC chip 100 is a part. Thus, the Delay Counter 206 goes HIGH and begins the time delay 300. The OTP Memory block 200 goes HIGH to self-initiate a beginning of the read-out process during the time delay 300 and driven by the clock driven, External Reset (RSTB) signal. The read-out process involves a read-out of the memory settings, including other memory contents, which output on the internal OTP Data/Control signal 202. The OTP Memory block 200 completes the read-out of its memory settings during the time delay 300, such that when the read-out of the OTP Memory block 200 is completed and output on the internal OTP Data/Control signal 202, the OTP Memory block 200 has become fully configured during the time delay 300, and the Chip Logic block 106 has become fully configured by the OTP data/control signals during the time delay 300.

During the time delay 300 the OTP Memory block 200 completes the read-out of its memory settings, including other memory contents. Additionally, at the end of the time delay 300, the Delay Counter 206 releases the input Clock signal 104 to provide the Internal Reset clock signal 212 set at HIGH, and to set the Chip Logic block at HIGH with the Internal Reset clock signal 212 set at HIGH, and wherein the Internal Reset clock signal 212 begins clock timing of the Chip Logic block 106 after the Chip Logic block has been fully configured during the time delay 300. FIG. 3 indicates that during the time delay 300, any Data/Control signal that may occur, including any UNKNOWN signal from an unauthorized source, is unable to access the system before the OTP Memory Block 200 completes the read-out of its memory settings, including other memory contents. Thus, the time delay 300 disables an attempt by an UNKNOWN signal to by-pass security controls present in the memory contents before the OTP Memory Block 200 completes the read-out of its memory settings and memory contents including the security controls. FIG. 3 further indicates that the Internal Reset 212 initiates at a time after the OTP Memory Block 200 completes the read-out of the memory settings and other memory contents. Thereafter, the OTP Data/Control 202 is enabled to be accessed and applied at a time that is either coincident with the Internal Reset 212 or thereafter, and is, either automatically VALID, or recognized as VALID by security controls following a complete read-out by the Memory Block 200. The combination of the delayed Internal Reset 212 and the time interval required to access and apply the OTP Data/Control 202 assures complete read-out by the Memory Block 200.

At any time later wherein the RSTB signal 102 is set to ground true active, for example, while under control of the system CPU, the RSTB signal 102 supplied to the Delay Counter 206 immediately sets the Delay Counter 206 to ground, which, in turn, sets the Internal Reset signal 212 to ground and the Chip Logic Block 106 to ground. Further, the RSTB signal 102 supplied to the OTP Memory block 200 immediately sets the OTP Memory block 200 to ground, causing the OTP Memory block 200 to reset and remain in reset mode.

Advantageously, the present invention provides memory read-out protection while attaining a fully configured OTP Memory block 200 and a fully configured Chip Logic block 106 without the use of diodes. According to an embodiment of the invention, the memory settings are protected by a diode-free, OTP and Reset Assert Counter 204. The OTP and Reset Assert Counter 204, being diode-free, reduces the overall cost of construction, speeds up the switching times compared to that of diodes, and reduces power consumption that would be consumed by diodes.

This description of the exemplary embodiments is intended to be read in connection with the accompanying drawings, which are to be considered part of the entire written description. In the description, relative terms such as “lower,” “upper,” “horizontal,” “vertical,”, “above” “below” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method of protecting one-time programmable memory settings during read-out, comprising:
inputting a Clock signal and a clock driven External Reset (RSTB) signal to a Delay Counter programmed with a time delay;
inputting the External Reset (RSTB) signal to an OTP memory block programmed with memory settings for configuring a Chip Logic Block;
setting the External Reset (RSTB) signal at HIGH, relative to ground, to set the Delay Counter at HIGH and to set the OTP Memory block at HIGH;
delaying the Clock signal during the time delay while the Delay Counter is set at HIGH;
beginning a read-out of the memory settings of the OTP memory block set at HIGH, such that during the time delay the read-out is completed, and the OTP memory block become fully configured during the time delay; and
releasing the delayed Clock signal at the end of the time delay to provide a delayed Internal Reset clock signal to begin timing of the Chip Logic block, after the Chip Logic block has become fully configured during the time delay.

2. The method of claim 1, comprising:
counting the time delay duration with the Clock signal inputted to the Delay Counter.

3. The method of claim 1, comprising:
asserting the end of the time delay by beginning the Internal Reset clock signal.

4. The method of claim 1, comprising
integrating the OTP memory block and the Delay Counter in an OTP and Reset Assert Counter semiconductor device.

5. The method of claim 4, comprising:
integrating the OTP and Reset Assert Counter in an ASIC chip.

6. The method of claim 1, comprising:
programming the Delay Counter with the time delay while the clock driven External Reset (RSTB) signal is at ground true active.

7. The method of claim 1, comprising:
programming the OTP Memory block with the memory settings while the clock driven External Reset (RSTB) signal is at ground true active.

8. The method of claim 1 wherein the External Reset (RSTB) signal is set at ground true active.

9. The method of claim 1 wherein the OTP memory block is set at ground and in a reset mode.

10. The method of claim 1 wherein the read-out of the memory settings includes an OTP Data/Control signal to a Chip Logic block.

11. An OTP and Reset Assert Counter for protecting one-time programmable memory settings during read-out, comprising:
an OTP memory programmed with memory settings and receiving a clock signal driven External Reset (RSTB) signal;
a delay counter receiving the clock driven External Reset (RSTB) signal, wherein the delay counter is programmed with a time delay to correspond with a time that is inherently needed by the OTP Memory block to complete a read-out process; and
the delay counter delaying the input Clock signal for a duration of at least the time delay.

12. The OTP and Reset Assert Counter of claim 11 wherein the OTP memory is set at ground while the External Reset (RSTB) signal is set at ground true active.

13. The OTP and Reset Assert Counter of claim 11 wherein the delay counter receiving the clock driven External Reset (RSTB) signal beginning with the External Reset (RSTB) signal being set to HIGH.

14. The OTP and Reset Assert Counter of claim 11 wherein the delay counter is programmed with the time delay that begins with the External Reset (RSTB) signal being set to HIGH.

15. The OTP and Reset Assert Counter of claim 11 wherein the delay counter delays the input Clock signal for a duration of at least the time delay that begins with the External Reset (RSTB) signal being set to HIGH.

16. The OTP and Reset Assert Counter of claim 11 wherein the OTP memory is set at ground and in reset mode while the External Reset (RSTB) signal is set at ground true active, and wherein the delay counter receives the clock driven External Reset (RSTB) signal beginning with the External Reset (RSTB) signal being set to HIGH.

17. The OTP and Reset Assert Counter of claim 11 wherein;
the OTP memory is set at ground and in reset mode while the External Reset (RSTB) signal is set at ground true active;
the delay counter receives the clock driven External Reset (RSTB) signal beginning with the External Reset (RSTB) signal being set to HIGH; and
the delay counter delays the input Clock signal for a duration of at least the time delay that begins with the External Reset (RSTB) signal being set to HIGH.

18. A method of protecting one-time programmable memory settings of the OTP and Reset Assert Counter of claim 11 during read-out, comprising:
inputting a Clock signal to a Delay Counter, inputting a clock driven External Reset (RSTB) signal to an Delay Counter programmed with a time delay;
inputting the External Reset (RSTB) signal to an OTP memory block programmed with memory settings for configuring a Chip Logic block;
setting the External Reset (RSTB) signal at HIGH, relative to ground, to set the Delay Counter at HIGH and to set the OTP Memory block at HIGH;
delaying the Clock signal during the time delay while the Delay Counter is set at HIGH;
beginning a read-out of the memory settings of the OTP memory block set at HIGH, such that during the time delay the read-out is completed, and the Chip Logic block and the OTP memory block become fully configured during the time delay; and
releasing the delayed Clock signal at the end of the time delay to provide a delayed Internal Reset clock signal to begin timing of the Chip Logic block, after the Chip Logic block has become fully configured during the time delay.

19. The method of claim 18, comprising:
counting the time delay duration with the Clock signal inputted to the Delay Counter.

20. The method of claim 18, comprising:
asserting the end of the time delay by beginning the Internal Reset clock signal.
